(19) United States
(12) Patent Application Publication
(10) Pub. No.: US 2018/0025544 A1
(43) Pub. Date: Jan. 25, 2018

(54) METHOD AND DEVICE FOR DETERMINING RENDERING INFORMATION FOR VIRTUAL CONTENT IN AUGMENTED REALITY

(71) Applicant: Philipp A. SCHOELLER, Ebenhausen (DE)

(72) Inventors: Philipp A. SCHOELLER, Ebenhausen (DE); Theo CHUPP, Ann Arbor, MI (US)

(21) Appl. No.: 15/217,667

(22) Filed: Jul. 22, 2016

(51) Int. Cl. G06T 19/00; G06K 9/32; G06T 7/00

(52) U.S. Cl. CPC G06T 19/006; G06T 7/0044; G06K 9/3275; G06T 2207/30204

(57) ABSTRACT

The present invention relates to techniques for determining rendering information for virtual content within an augmented reality. The technique may comprise capturing an image comprising a graphical tag by an image capturing unit, wherein the graphical tag comprises one or more geometric objects, and the graphical tag representing coded information. Size reference information may then be obtained from the captured image and a distortion of a captured view of one of the geometric objects may then be determined. Thereafter, based on the size reference information and the distortion of the captured view, a relative position of the graphical tag to the image capturing unit may be determined. Based on the determined relative position, positioning information and scaling information for rendering the virtual content within an augmented reality relative to the graphical tag may then be determined.

### BACKGROUND

Devices for implementing and interacting with virtual content in an augmented reality become more and more common. Augmented reality (AR) relates to a live direct or indirect view of a physical, real-world environment whose elements are augmented (or supplemented) by computer-generated sensory input such as sound, video, graphics or GPS data.

Examples of virtual objects in AR may be graphical objects that are positioned at predefined positions in the real world, for example graphical notes overlaid to a machine for supporting a technician in operating and/or servicing the machine. For example, a user may wear AR glasses comprising a video camera for capturing substantially the same field of vision that the user sees. The AR glasses further comprise a display or projector for rendering computer-generated graphics within the glasses so that the user experiences an augmented reality.

There are many other applications that use augmented reality comprising: industry, medicine, travel industry, gaming industry, advertising industry, science, military, navigation, office workplaces, sport and entertainment, stock markets, translation, visual art, and much more. Even though the present invention mainly refers to AR glasses for implementing the invention, other AR devices are available such as smart phones, smart contact lenses or head-up displays in cars or airplanes etc.

Problems in the prior art arise when rendering parameters for the virtual content to be displayed is to be determined. For example, when essential information has to be displayed at a certain point in the augmented reality, it is not always easy to implement an accurate positioning of the virtual content relative to the real world. In case a user moves, the correct positioning is even more complex and requires high computing power to update rendering parameters, for example when a viewing angle or distance changes.

### SUMMARY OF THE INVENTION

It is therefore the invention to provide an improved computer-implemented method and device for determining rendering information for virtual content within an augmented reality.

This object is solved by the subject matter of the independent claims.

Preferred embodiments are defined by the dependent claims.

According to an embodiment of the invention, a computer-implemented method for determining rendering information for virtual content within an augmented reality is provided. The method may comprise capturing an image comprising a graphical tag. For capturing the image, an image capturing unit may be used. The graphical tag may comprise one or more geometric objects, and the graphical tag may represent coded information.

The method may further comprise obtaining from the captured image size reference information. The size reference information may for example indicate a physical size of the graphical tag or other information that can be used to determine a distance between the graphical tag and the image capturing unit. According to an embodiment, the size reference information may be the physical size coded into the graphical tag, or may be a reference to an entry in a table comprising size reference information. In an embodiment, the size reference information may further be determined by presence of a second graphical tag that is located at a predetermined distance from the first graphical tag.

The method further comprises determining a distortion of a captured view of at least one of said geometric objects. For example, when the image capturing unit captures the image comprising the graphical tag from a non-perpendicular direction from the graphical tag, it may be important to determine the exact viewing angle and direction. In this regard, according to an embodiment of the invention, the changed aspect ratio of one or more geometric objects is determined due to the distortion of the viewing angle.

Further, the method comprises determining, based on the size reference information and the distortion of the captured view, a relative position of the graphical tag to the image capturing unit. For example, when the distance of the image capturing unit and the graphical tag is determined, e.g. based on the size reference information, and the viewing angle and viewing direction between the graphical tag and the image capturing unit is determined, e.g. based on the determined distortion, the relative position of the graphical tag to the image capturing unit may be determined in a very precise manner.

As a next step, the method comprises determining, based on the determined relative position, positioning information and scaling information for rendering the virtual content within an augmented reality relative to the graphical tag. Since the relative positioning (i.e. a distance, a direction and an angle) between the graphical tag and the image capturing unit are known, the positioning information and scaling information, i.e. the required rendering information are readily determined.

Based on the determined rendering information, the virtual content may be rendered within the augmented reality using the determined positioning information and scaling information. For example, a virtual graphical object may be displayed in AR glasses of a user at a predefined position that can be easily identified due to the present invention.

According to an embodiment of the present invention, the coded information may comprise a source for the virtual content and/or the size reference information. For example, the graphical tag may be a scannable code that references to a web address where the virtual content may be downloaded. In addition to the virtual content itself, the size reference information may be downloaded from the web address or the size reference information may be coded within the graphical tag.

According to an embodiment of the present invention, determining the relative position of the graphical tag to the image capturing unit may comprise determining a distance, a direction and an angle between the graphical tag and the image capturing unit. Determining the relative position of the graphical tag to the image capturing device may further comprise determining a degree of distortion and a direction of distortion of the one or more geometric objects, wherein the degree of distortion is determined by analyzing an aspect ratio of at least one of said one or more geometric objects.

According to an embodiment of the present invention, the determining the positioning information and scaling information may comprise dynamically updating the orientation of the virtual content by updating the positioning information and scaling information when the relative position of the graphical tag and the image capturing unit changes. For example, a change of the distortion or the distance may be monitored and based on the monitoring, a movement of the image capturing device or the graphical tag may be determined. Thus, the method can quickly react to such positioning changes and update the rendering parameters.

According to an embodiment of the present invention, the coded information may further comprise an indication of a category of the virtual content. For example, the indication of the category may relate to digital rights management (DRM) or to a specification of the content itself, such as advertising, shopping information, age-based restrictions, and so on.

An embodiment of the invention relates to a corresponding device for determining rendering information for virtual content within an augmented reality. The device may be implemented at least as part of, for example, a head up display, smart glasses, a mobile phone, a tablet PC, etc. However, the embodiments of the present invention are not limited to one of the specific hardware configurations, but may be implemented in any hardware that facilitates an environment for implementing the described methods of the invention.

### BRIEF DESCRIPTION OF THE FIGURES

The above and other aspects, features, and advantages of the present invention will be more apparent from the following detailed description when taken in conjunction with the accompanying drawings, in which:

FIGS. 1 and 2 illustrate a possible application for the present invention, according to an embodiment of the present invention;

FIG. 3 illustrates an exemplary graphical tag comprising coded information and geometric objects, according to an embodiment of the present invention;

FIG. 4 illustrates a concept of determining a distortion caused by a non-perpendicular viewing axis between the graphical tag and the image capturing unit, according to an embodiment of the present invention;

FIG. 5 illustrates a concept of determining a rotation caused by rotated viewing angle between the graphical tag and the image capturing unit, according to an embodiment of the present invention; and

FIG. 6 illustrates a concept of determining distance between two graphical tags and the image capturing unit, according to an embodiment of the present invention.

### DETAILED DESCRIPTION

Embodiments of the present invention provide a concept of improving management of rendering parameters for rendering virtual objects in an augmented reality. Additionally, an embodiment of the present invention relates to the obtaining of virtual content that is to be rendered as part of the augmented reality.

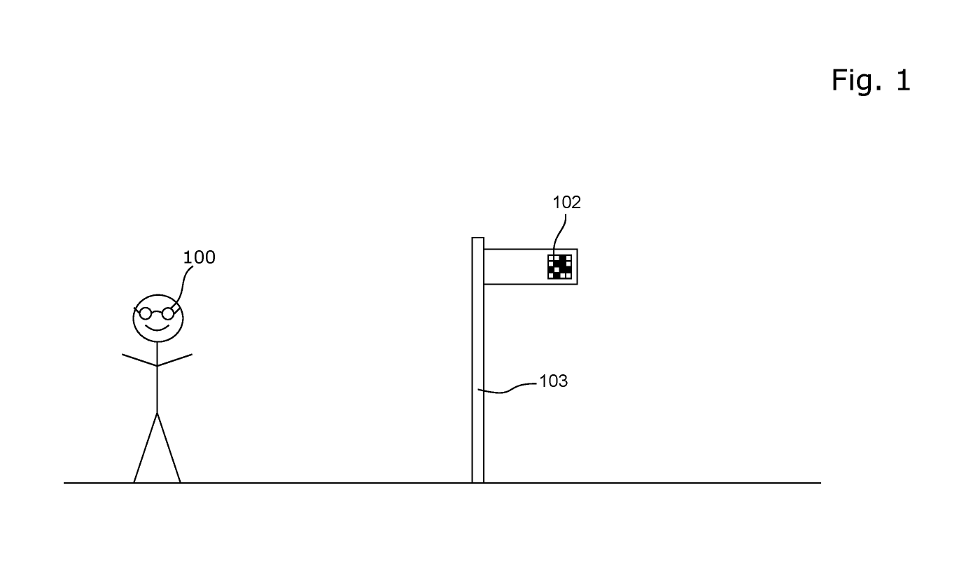

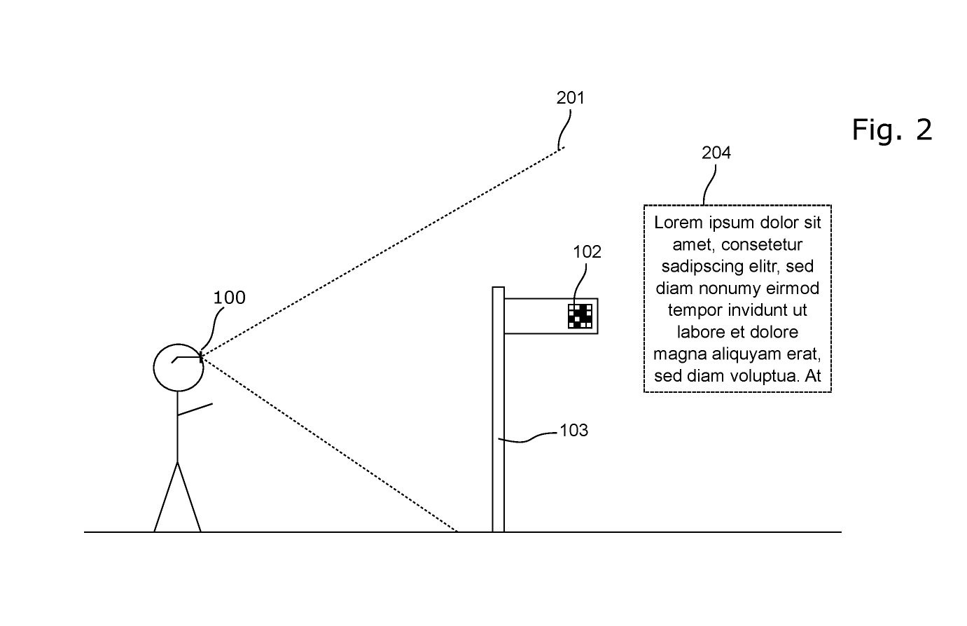

FIGS. 1 and 2 illustrate a possible application for the present invention, according to an embodiment of the present invention. In particular, FIG. 1 shows a user wearing augmented reality (AR) glasses 100. The AR glasses 100 may comprise different hardware components, such as an image capturing unit for capturing substantially the same view of the user, an eye tracking unit for capturing an image of the user's eye(s) and determining a viewing direction of the user, a data communications interface for exchanging data with other devices or networks, such as the internet, a display unit for displaying or projecting virtual objects into the field of vision of the user, and a processing unit for processing commands and controlling the operations of the other components and units. The AR glasses 100 may include more a less components or units.

The data communications interface of the AR glasses 100 may be, for example, a Bluetooth interface, a Wi-Fi interface, or any other wireless interface for exchanging data with a network or with another device, such as a smart phone. For example, data may be exchanged with the Internet by using a wireless interface of the AR glasses 100 that connects the AR glasses 100 with a smart phone that is connected to the Internet. However, the AR glasses 100 may also comprise an interface for directly communicating with the Internet, such as by using Wi-Fi and/or an interface of the cellular standard, such as LTE or other GSM/EDGE and UMTS/HSPA network technologies.

According to an embodiment, the user may not necessarily wear AR glasses 100 but may instead use another AR device, such as a smart phone or any other device for augmenting reality.

Referring to FIG. 1, the user wearing the AR glasses 100 may be near a graphical tag 102 that may be mounted at any place in the real world. In the example of FIG. 1, the graphical tag 102 is mounted on a guidepost 103. However, any other position may be appropriate, such as on a wall, on a car, on a machine, on a desk, on a tree, in a museum, and so on.

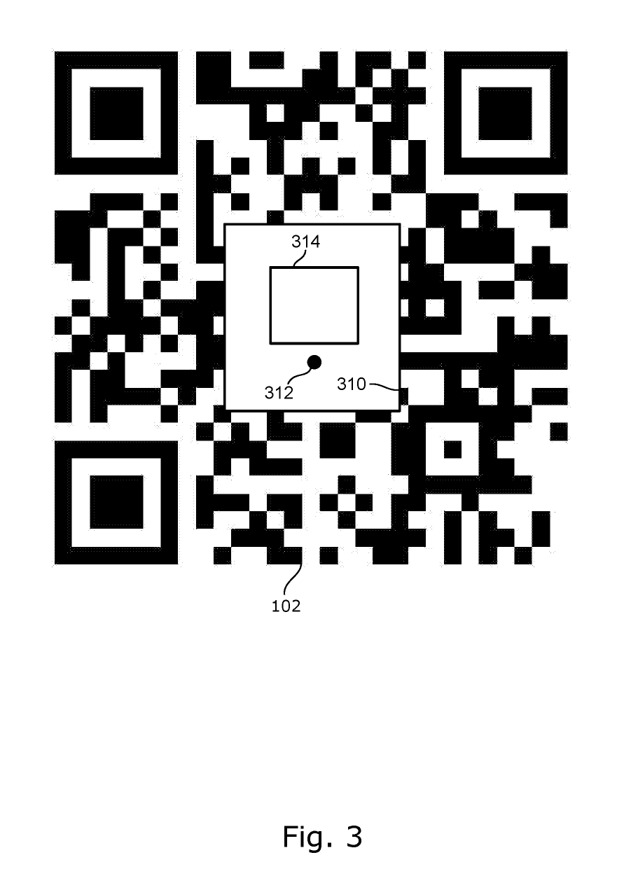

The graphical tag 102 may comprise a scannable code that references to and/or comprises coded information. As will be discussed in greater details below, the coded information of the graphical tag 102 may comprise different information items, such as size reference information. The encoded size reference information of the graphical tag 102 may be the actual physical size of the scannable code, i.e. of the graphical tag, that may be required for determining a distance between the graphical tag 102 and the image capturing unit. The graphical tag 102 may be, for example, a modified quick response code (QR code), or any other matrix barcode. More details of an exemplary graphical tag will be described with reference to FIG. 3.

According to FIG. 2, the user wearing the AR glasses 100 looks into the direction of the graphical tag 102, so that the graphical tag 102 appears within a field of view 201 of the image capturing unit of the AR glasses 100. When the image capturing unit of the AR glasses 100 identifies the graphical tag 102, the processing unit of the AR glasses or a processing unit of a connected smart phone may automatically decode the coded information of the graphical tag 102. Notably, the present invention is not limited to a specific device decoding the coded information of the graphical tag. It can be decoded by the AR glasses 100 or the AR device directly or can be decoded by a smart phone that is connected to the AR device/AR glasses 100 or may be decoded by another device that is connected to the AR device/AR glasses 100 over the internet.

The coded information of the graphical tag 102 may comprise information for obtaining virtual content 204 to be displayed as part of the augmented reality. The coded information may for example comprise an URL to the virtual content so that the virtual content 204 can be downloaded from that URL and displayed via the AR glasses 100 at a predefined position. Thus, the coded information may further comprise instructions for determining positioning information of how to render the virtual content 204 relative to the graphical tag 102.

The virtual content 204 can be of any form and kind that may be displayed or rendered as part of an augmented reality. In the example of FIG. 2, the virtual content 204 is a placard showing some text, such as tourist information text near a tourist attraction. However, the virtual content 204 can be of any other form. Importantly, and as will be described in greater detail below, the present invention provides a concept of determining rendering parameters for correctly rendering the size, position an perspective of the virtual content 204 in dependency of the location of the AR glasses 100 relative to the graphical tag 102.

In the following, some non-limiting examples of applications for the present invention are provided. In a first example, the graphical tag 204 may be mounted on a wall of a house.

When a user wearing the AR glasses 100 comes close enough so that the image capturing unit captures an image of the graphical tag 102, the coded information of the graphical tag 102 is decoded and a relative position of the AR glasses 100 to the graphical tag 102 is determined. The determining of the relative position will be discussed in more detail below. The coded information of the graphical tag may, for example, be a reference to a 3D graphic that is to be rendered within the augmented reality, such as virtual decoration of the house. As such, in the above example, the user wearing the AR glasses 100 may see additional decoration of the house, such as a different painting of the walls, plants and trees or more abstract virtual content, such as the 3D image of a skyscraper instead of the house.

In another example, the graphical tag 102 may be used for interactive computer games, where one or more graphical tags 102 may be mounted at specific locations and users wearing AR glasses 100 can interact with virtual content that is displayed in the area around the graphical tag(s) 102. By using the technique described by the present invention, users may experience a much more realistic behavior of virtual objects as the virtual content according to the present invention can be placed at a defined position more accurately without being effectuated by unrealistic movement of the virtual content due to a movement of the user. In other words, many computer games already exist where smart phones or smart glasses are used for augmenting the reality and presenting virtual objects to the user that are part of the computer game. A user can then interact with the virtual objects (virtual content) through the AR device. However, when the AR device moves, the rendering parameters of the virtual object are most often not updated and adapted in a sufficient and realistic manner. This problem may be solved by the present invention, as will be discussed in greater detail below.

In still another example, the graphical tag may be positioned at locations where a user input through a keyboard may be required. For example, due to the very stable positioning of virtual content 204 within the augmented reality, the virtual content 204 may be a virtual keyboard for receiving user inputs. Such an embodiment may be advantageous in food industry, for example in aseptic environments, where operating with machines has to be sterile. As such, servicing or operating with sterile machines in aseptic environments may no longer require a physical keyboard or physical buttons, as virtual keyboards and buttons may be placed as augmented reality at predefined positions and locations. Thus, users or operators of the machines do not have to touch anything in critical environments, but can still make user inputs. Due to the very stable positioning of virtual content in the augmented reality, it may even be possible to interact with rather small keys on a keyboard. In particular, since embodiments of the present invention allow positioning of virtual content in an augmented reality in such a fixed and precise manner, a user may even interact with small virtual objects, such as virtual keys of a virtual keyboard. Thus, instead of installing a physical keyboard in the real world, a graphical tag 102 referencing a virtual keyboard may be mounted.

As described in the above example, embodiments of the present invention do not only provide passive virtual content, such as decoration objects or 3D graphics, but may further provide interactive virtual content that can be manipulated through user inputs and user interactions. For example, the image capturing unit of the AR glasses 100 may further capture the hand and/or fingers of the user and determine a user interaction with the displayed virtual content. When such a user interaction is determined, the virtual content may be altered or changed and so on.

There are many further examples of applications for the present invention. For example, the graphical tag 102 may be a wearable graphical tag, such that it is printed on a shirt. When the shirt is then viewed through AR glasses 100, the shirt may appear in a different design or color. In still another embodiment, the graphical tag 102 may reference to multimedia applications, where virtual content 204 is multimedia content that may be downloaded and displayed to the user, such as animated advertising or videos. Since some AR devices may further comprise a sound output unit, such as loudspeaker, the virtual content 204 may not only be a graphical content, but may further comprise sound.

Since users wearing the AR glasses 100 may not be willing to receive all available virtual content, the coded information may further comprise an indication of a category of the virtual content. Additionally, the indication of the category may relate to digital rights management (DRM) or to a specification of the content itself, such as advertising, shopping information, age-based restrictions, and so on. For example, the AR glasses 100 may be set to ignore virtual content 204 of the category “advertising”. In one embodiment, the user may only be allowed to download and render the virtual content 204 if the user has the corresponding rights (e.g. DRM, age verification, privacy settings, etc.).

FIG. 3 illustrates an exemplary graphical tag 102 comprising coded information and geometric objects, according to an embodiment of the present invention. The embodiment of FIG. 3 shows a modified QR code that has been equipped with additional geometric objects, such as a square 314 and a dot 312 residing in a box 310. Notably, the geometric objects 312 and 314 are merely an example, and more or fewer or other geometric objects may be used. Further, the QR code itself already comprises geometric objects that may be used for implementing the present invention so that the geometric objects 312 and 314 increase the accuracy of determining relative positions. Still further, the implementation of a QR code as graphical tag 102 is an example only and the present invention is not limited to using QR codes. In particular, every 2D matrix code comprising geometric objects may be used as long as the graphical tag comprises graphical objects and may be used to code information.

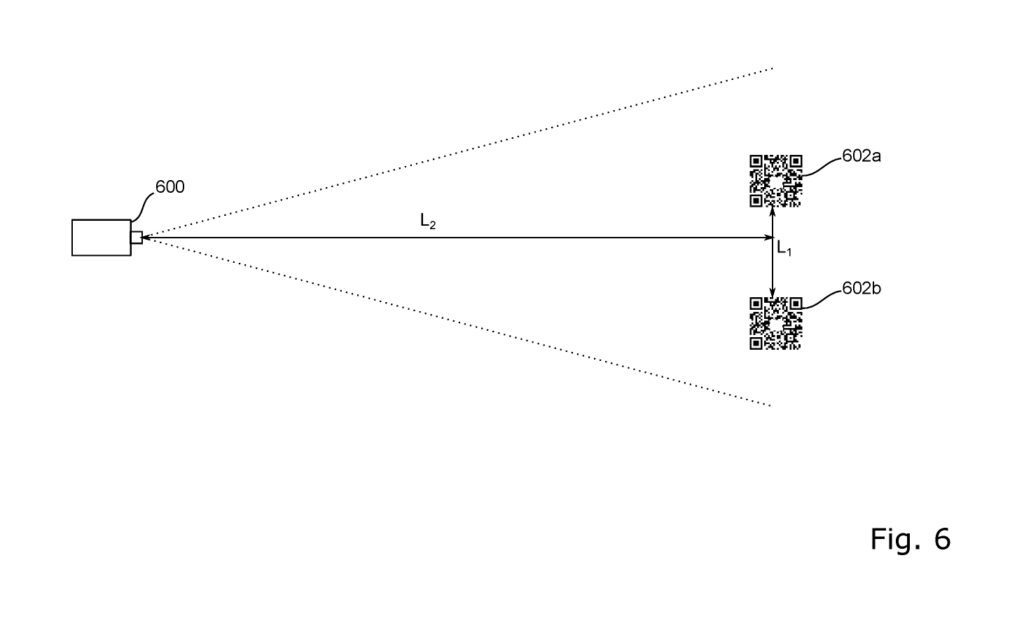

As mentioned above, the coded information may not only refer to the virtual content 204, but may further comprise size reference information. For example, the size reference information may indicate an actual size of the graphical tag 102 or other information that can be used to determine a distance between the graphical tag and the image capturing unit. According to an embodiment, the size reference information may be the physical size coded into the graphical tag, or may be a reference to an entry in a table comprising size reference information. In an embodiment, the size reference information may further be determined by presence of a second graphical tag that is located at a predetermined distance from the first graphical tag. An example for using two graphical tags will be explained with regard to FIG. 6. When the physical size of the graphical tag 102 is known to the AR device 100, the AR device 100 may calculate the distance between the AR device 100 and the graphical tag 102. For example, the “measured” size of the graphical tag 102 within the captured image taken by the image capturing unit compared to the size reference information of the graphical tag 102 allows determining the distance between the graphical tag 102 and the image capturing unit.

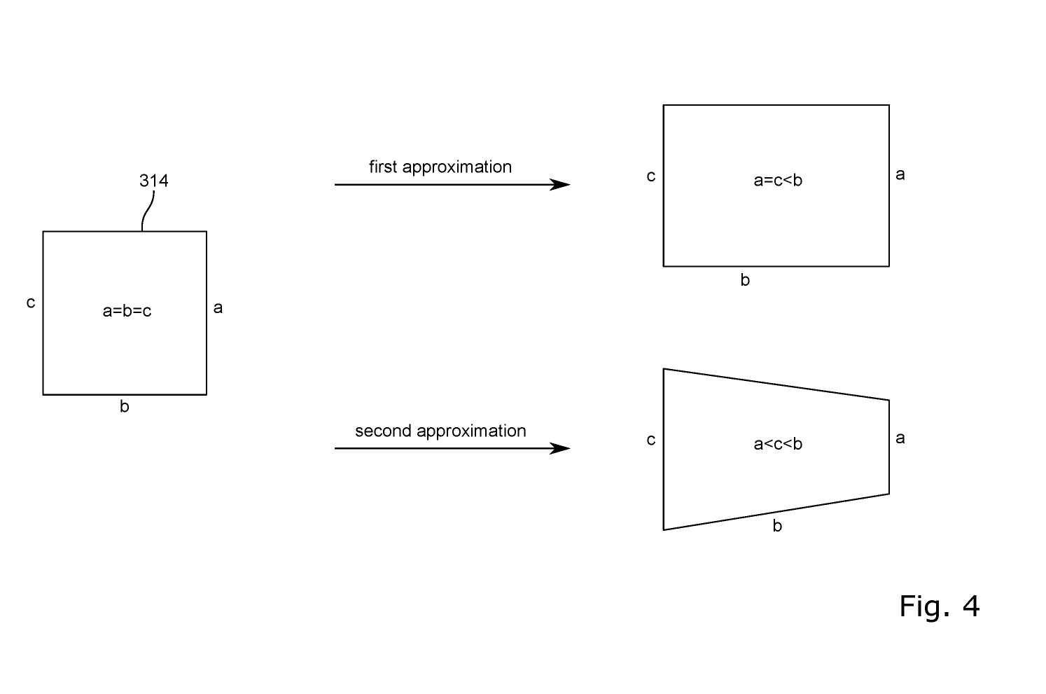

The geometric objects 312 and 314 may be used to determine a viewing direction of the image capturing unit towards the graphical tag 102. In particular, by determining a distortion of the captured view of one or more of the geometric objects 312 and 314, the viewing direction may be determined. Thus, based on the size reference information and the distortion of the captured view, the relative position of the graphical tag 102 to the image capturing unit may be determined, as will be discussed in greater detail with regard to FIG. 4.

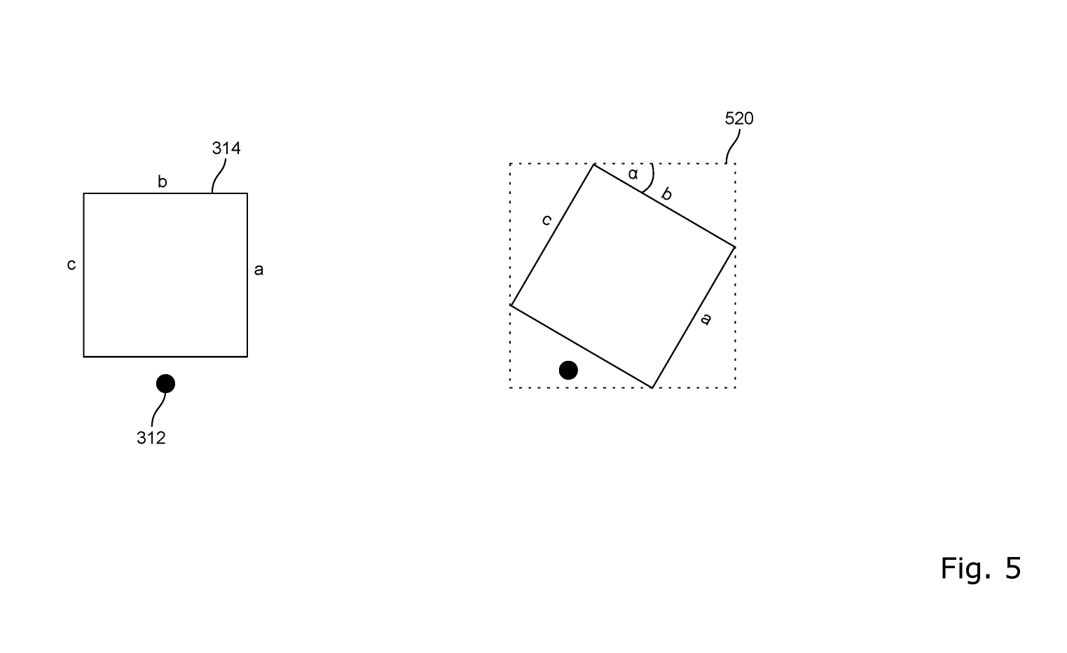

To further increase accuracy of the relative position of the graphical tag to the image capturing unit, an angle around the connecting line between image capturing unit and graphical tag 102 may further be determined, as will be discussed in greater detail with regard to FIG. 5.

FIG. 4 illustrates a concept of determining a distortion caused by a non-perpendicular viewing axis between the graphical tag 102 and the image capturing unit, according to an embodiment of the present invention. In particular, when the viewing direction of the image capturing unit onto the graphical tag 102 is not perpendicular to the surface of the graphical tag 102, the geometric objects appear to be distorted, i.e. the aspect ratio of a geometric object changes.

As can be seen in FIG. 4, the sides a, b and c of the square 314 have equal lengths a=b=c. However, when capturing the geometric object, i.e. square 314, from a non-perpendicular direction, the aspect ratio of the sides a, b and c changes. For example, in a first approximation the square 314 may become a rectangle with the new aspect ratio (or captured aspect ratio) a=c<b. In a second approximation, the square may become a trapeze with the aspect ratio of a<c<b. Thus, by determining the aspect ratio/the distortion of the captured view of the geometric object 314, the viewing direction of the image capturing unit may be determined.

As a consequence, the relative position of the graphical tag 102 to the image capturing unit may be determined based on the size reference information and the determined distortion of the captured view of at least one of the geometric objects.

It should be understood that the square 314 of FIG. 4 is an example only. Other geometric shapes are possible and will be distorted accordingly. For example, a circle may become an ellipse. However, also more complex geometric shapes or an assemble of multiple geometric shapes may be used and can achieve even more accurate results of the distortion determination.

FIG. 5 illustrates a concept of determining a rotation caused by a rotated viewing angle between the graphical tag and the image capturing unit, according to an embodiment of the present invention. For example, in order to increase the accuracy of the relative position of the graphical tag 102 to the image capturing unit, the combination of at least two geometric objects 312 and 314 may be used. In particular, the geometric objects 312 and 314 are placed in a predefined relation to each other, such as object 312 being placed directly below object 314. When the angle around the connecting line between image capturing unit and graphical tag 102 changes, for example because the user rotates his/her head while wearing the AR glasses 100, a non-zero angle α between a side of the square 314 and a virtual box 520 occurs. The virtual box 520 may be a tool implemented in the image capturing unit, such as a digital spirit level or a horizontal line and a vertical line of pixels of the sensor of the image capturing unit. However, the present invention is not limited to the digital spirit level or the defined lines of sensor pixels.

It should be understood that the example of the square 314 and the dot 312 is for illustrative purposes only and should not be understood as a limitation of the present invention. Other geometric aspects may also be used, such as the shape of an arrow, or a rectangle, or more complex geometric objects that allow the determination of an orientation angle.

After the relative position of the graphical tag to the image capturing device has been determined, the rendering information may be determined. The rendering information may comprise positioning information of the virtual content 204 relative to the graphical tag and scaling information for rendering the virtual content 204 within the augmented reality.

The determining of the positioning information and scaling information for rendering the virtual content 204 within the augmented reality may further be based on rendering instructions contained in the coded information of the graphical tag 102. The rendering instructions may specify that the virtual object 204 is to be displayed at a predetermined relative distance and direction from the graphical tag 102. For example, the rendering instructions may specify that the virtual object 204 is to be displayed 1 m above and 2 m on the left side of the graphical tag 102.

As such, when the rendering information has been successfully determined, the virtual content 204 may be rendered, i.e. displayed or projected, within the augmented reality using the determined positioning information and scaling information.

The above described technique for determining the rendering information, i.e. the positioning information and the scaling information for rendering the virtual content, may be dynamically repeated for updating the rendering information continuously. For example, when the user moves, the rendering information is automatically updated so that the user experiences a very realistic view of the virtual content and the augmented reality.

FIG. 6 illustrates a concept of determining the distance between two graphical tags and the image capturing unit, according to an embodiment of the present invention. According to an embodiment, more than one graphical tag 102 may be used to provide an augmented reality.

This may be advantageous for larger virtual content. FIG. 6 shows an image capturing unit 600 that captures an image comprising two graphical tags 602a and 602b. The two graphical tags 602a and 602b may be arranged in a distance L₁ from each other. The distance L₁ between the graphical tags 602a and 602b may be a standardized, i.e. predefined, distance.

According to an embodiment, the distance L₁ between the two graphical tags 602a and 602b may be part of the coded information of the graphical tags 602a and 602b. In other words, the graphical tag 602a comprises coded information of the distance and direction towards the graphical tag 602b, and vice versa. Thus, when the distance L₁ is known, the distance L₂ between the graphical tags 602a/602b and the image capturing unit 600 in FIG. 6 may be easily determined. The distance L2 may refer to the distance between the image capturing unit 600 and one of the two graphical tags 602a and 602b, or may refer to the distance between the image capturing unit 600 and a predetermined point between the two graphical tags 602a and 602b.

1. A computer-implemented method for determining rendering information for virtual content within an augmented reality, the method comprising:
capturing an image comprising a graphical tag by an image capturing unit, wherein the graphical tag comprises one or more geometric objects, and the graphical tag representing coded information;
obtaining from the captured image size reference information;
determining a distortion of a captured view of at least one of said geometric objects;
determining, based on the size reference information and the distortion of the captured view, a relative position of the graphical tag to the image capturing unit; and
determining, based on the determined relative position, positioning information and scaling information for rendering the virtual content within an augmented reality relative to the graphical tag.

2. The computer-implemented method of claim 1, further comprising rendering the virtual content within the augmented reality using the determined positioning information and scaling information.

3. The computer-implemented method of claim 1, wherein said coded information comprises a source for the virtual content and/or the size reference information.

4. The computer-implemented method of claim 1, wherein determining the relative position of the graphical tag to the image capturing unit comprises determining a distance, a direction and an angle between the graphical tag and the image capturing unit.

5. The computer-implemented method of claim 1, wherein determining the relative position of the graphical tag to the image capturing device comprises determining a degree of distortion and a direction of distortion of the one or more geometric objects, wherein the degree of distortion is determined by analyzing an aspect ratio of at least one of said one or more geometric objects.

6. The computer-implemented method of claim 1, wherein the determining the positioning information and scaling information comprises dynamically updating the orientation of the virtual content by updating the positioning information and scaling information when the relative position of the graphical tag and the image capturing unit changes.

7. The computer-implemented method of claim 1, wherein the coded information further comprises an indication of a category of the virtual content.

8. A device for determining rendering information for virtual content within an augmented reality, the device comprising:
an image capturing unit for capturing an image comprising a graphical tag, wherein the graphical tag comprises one or more geometric objects, and the graphical tag representing coded information; and
a processing unit configured to:
obtaining from the captured image size reference information;
determining a distortion of a captured view of at least one of said geometric objects;
determining, based on the size reference information and the distortion of the captured view, a relative position of the graphical tag to the image capturing unit; and
determining, based on the determined relative position, positioning information and scaling information for rendering the virtual content within an augmented reality relative to the graphical tag.

9. The device of claim 8, further comprising a rendering unit for rendering the virtual content within the augmented reality using the determined positioning information and scaling information.

10. The device of claim 8, wherein said coded information comprises a source for the virtual content and/or the size reference information.

11. The device of claim 8, wherein determining the relative position of the graphical tag to the image capturing unit comprises determining a distance, a direction and an angle between the graphical tag and the image capturing unit.

12. The device of claim 8, wherein determining the relative position of the graphical tag to the image capturing device comprises determining a degree of distortion and a direction of distortion of the one or more geometric objects, wherein the degree of distortion is determined by analyzing an aspect ratio of at least one of said one or more geometric objects.

13. The device of claim 8, wherein the determining the positioning information and scaling information comprises dynamically updating the orientation of the virtual content by updating the positioning information and scaling information when the relative position of the graphical tag and the image capturing unit changes.

14. The device of claim 8, wherein the coded information further comprises an indication of a category of the virtual content.
